(19) United States
(12) Patent Application Publication
(10) Pub. No.: US 2026/0170853 A1
(43) Pub. Date: Jun. 18, 2026

(54) PERSON DETECTION METHOD, VEHICLE CONTROL METHOD, NON-TRANSITORY COMPUTER READABLE MEDIUM, PERSON DETECTION APPARATUS, AND VEHICLE CONTROL SYSTEM

(71) Applicant: TOYOTA JIDOSHA KABUSHIKI KAISHA, Toyota-shi (JP)

(72) Inventor: Masayuki YAMAZAKI, Yokohama-shi (JP)

(73) Assignee: TOYOTA JIDOSHA KABUSHIKI KAISHA, Toyota-shi (JP)

(21) Appl. No.: 19/411,722

(22) Filed: Dec. 8, 2025

(30) Foreign Application Priority Data
Dec. 18, 2024 (JP) 2024-223595

(51) Int. Cl. G06V 20/59; B60R 25/31; G06T 7/00; G06V 10/62

(52) U.S. Cl. CPC G06V 20/59; B60R 25/31; G06T 7/97; G06V 10/62; G06T 2207/30268

(57) ABSTRACT

A person detection method includes acquiring a difference value of time-series data of multiple captured images, when the difference value is equal to or greater than a predetermined value, executing a first detection process to detect a person based on a subsequent image in a time series among the multiple captured images used to acquire the difference value, and when the difference value is less than the predetermined value, executing a second detection process to detect a person based on a previous image in the time series among the multiple captured images used to acquire the difference value.

### CROSS-REFERENCE TO RELATED APPLICATION

This application claims priority to Japanese Patent Application No. 2024-223595, filed on Dec. 18, 2024, the entire contents of which are incorporated herein by reference.

### TECHNICAL FIELD

The present disclosure relates to a person detection method, a vehicle control method, a non-transitory computer readable medium, a person detection apparatus, and a vehicle control system.

### BACKGROUND

As described in Patent Literature (PTL) 1, a person tracking method that includes the step of recognizing and detecting a person to be tracked from images captured by an imager capturing a monitoring area from above, and the step of recognizing and tracking the detected person from subsequent frames of the captured images is known.

### Citation List

### Patent Literature

PTL 1: JP 2024-057695 A

### SUMMARY

Regardless of the presence or absence of a person's motion, the output of person segmentation may decrease and be lost due to changes in the way the person is captured in time-series data of images capturing the person. There is a demand for improving the stability of segmentation for time-series data of images.

It would be helpful to enhance the stability of person segmentation for time-series data of images.

A person detection method according to an embodiment of the present disclosure includes:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

A vehicle control method according to an embodiment of the present disclosure includes prohibiting execution of a predetermined operation of a vehicle when a person detected by the person detection method is present in a predetermined space provided in the vehicle.

A non-transitory computer readable medium according to an embodiment of the present disclosure stores a person detection program. The person detection program is configured to cause a processor to execute operations including:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

A person detection apparatus according to an embodiment of the present disclosure includes a controller. The controller is configured to:
acquire a difference value of time-series data of multiple captured images;
when the difference value is equal to or greater than a predetermined value, execute a first detection process to detect a person based on a subsequent image in a time series, among the multiple captured images used to acquire the difference value; and
when the difference value is less than the predetermined value, execute a second detection process to detect a person based on a previous image in the time series, among the multiple captured images used to acquire the difference value.

A vehicle control system according to an embodiment of the present disclosure includes the person detection apparatus and a vehicle control apparatus. The vehicle control apparatus is configured to prohibit execution of a predetermined operation of a vehicle when a person detected by the person detection apparatus is present in a predetermined space provided in the vehicle.

The person detection method, the vehicle control method, the non-transitory computer readable medium, the person detection apparatus, and the vehicle control system according to an embodiment of the present disclosure can enhance the stability of person segmentation for time-series data of images.

### BRIEF DESCRIPTION OF THE DRAWINGS

In the accompanying drawings:

FIG. 1 is a block diagram illustrating an example of a configuration of a detection system according to the present disclosure;

FIG. 2 is a schematic diagram illustrating an example of a configuration of a person detection model;

FIG. 3 is a flowchart illustrating an example procedure of a person detection method according to the present disclosure;

FIG. 4 is a block diagram illustrating an example of a configuration of a vehicle control system according to the present disclosure;

FIG. 5 is a flowchart illustrating an example procedure of a vehicle control method according to the present disclosure;

FIG. 6 is a schematic diagram explaining intrusion determination using a person detection rectangle; and

FIG. 7 is a schematic diagram explaining intrusion determination using a person region.

### DETAILED DESCRIPTION

### Example of Configuration of Detection System 1

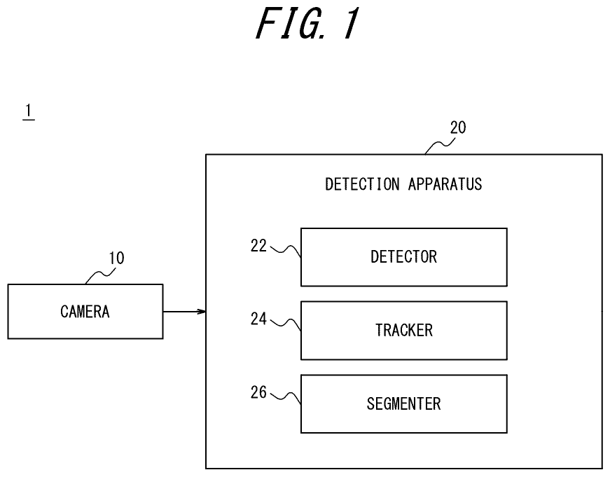

As illustrated in FIG. 1, a detection system 1 according to the present disclosure includes a camera 10 and a detection apparatus 20. The detection system 1 captures images of a detection target region with the camera 10, and detects persons present in the detection target region by analyzing the captured images with the detection apparatus 20. The detection target region is, for example, a region inside a vehicle or a surrounding region of the vehicle, but is not limited to these.

The camera 10 is installed to capture images of the detection target region. The camera 10 may be installed to capture images of the detection target region from above. The camera 10 may be configured to capture images of the detection target region using a fisheye lens. The camera 10 may be configured to capture light of various wavelengths such as visible light or infrared light. The camera 10 may be replaced with radar, a finder, or the like.

The detection apparatus 20 includes a detector 22, a tracker 24, and a segmenter 26. The detection apparatus 20 may be configured with one or more processors or dedicated circuits to realize the functions of the detector 22, the tracker 24, and the segmenter 26. In the present embodiment, the processors are general purpose processors or dedicated processors specialized for specific processing, but are not limited to these. The dedicated circuits may include, for example, field-programmable gate arrays (FPGAs) or application specific integrated circuits (ASICs). The detector 22, the tracker 24, and the segmenter 26 may each be composed of separate processors or dedicated circuits. At least two of the detector 22, the tracker 24, and the segmenter 26 may be composed of one processor or dedicated circuit. The detector 22, the tracker 24, and the segmenter 26 are collectively referred to as a controller.

The detection apparatus 20 may be configured with a memory. The memory may be configured with, for example, a semiconductor memory, a magnetic memory, an optical memory, or the like, but is not limited to these. The memory may function, for example, as a main memory, an auxiliary memory, or a cache memory. The memory may be configured with an electromagnetic storage medium, such as a magnetic disk. The memory may be configured with a non-transitory computer readable medium. The memory stores any information or programs used for operations of each of the detector 22, the tracker 24, and the segmenter 26. The memory may store, for example, a system program, an application program, or the like. The memory may be included in the processors, the dedicated circuits, or the like.

The detection apparatus 20 may be configured with an interface that communicates information, data, or the like with other components of the detection system 1, such as the camera 10, or external apparatuses. The interface may include a communication module configured to be communicable with the other components or the external apparatuses via a network. The communication module may be, for example, compliant with a mobile communication standard, such as the 4th Generation (4G) standard or the 5th Generation (5G) standard. The communication module may be compliant with a communication standard, such as a Local Area Network (LAN). The communication module may be compliant with a wired or wireless communication standard. The communication module is not limited to these examples and may be compliant with various communication standards. The interface may be configured to be connectable to a communication module. The interface may be equipped with terminals that correspond to a standard such as RS-232C or RS-485 so as to be directly connected to other components of the detection system 1, such as the camera 10, or external apparatuses.

The detection apparatus 20 may be configured with an input device for accepting input of information, data, or the like from a user of the detection system 1. The input device may be configured with, for example, a touch panel or touch sensor, or a pointing device such as a mouse. The input device may be configured with a physical key. The input device may be configured with an audio input device, such as a microphone. The detection apparatus 20 may be configured to be connectable to an external input device. The detection apparatus 20 may be configured to be able to acquire, from the external input device, information or data input to the external input device.

The detection apparatus 20 may be configured with an output device that outputs information or data to the user. The output device may include, for example, a display device that outputs visual information, such as images, or letters or graphics. The display device may be configured with, for example, a Liquid Crystal Display (LCD), an organic or inorganic Electro-Luminescent (EL) display, a Plasma Display Panel (PDP), or the like. The display device is not limited to the above displays and may be configured with various other types of displays. The display device may be configured with light emitting devices, such as Light Emitting Diodes (LEDs) or Laser Diodes (LDs). The display device may be configured with various other devices. The output device may include, for example, an audio output device, such as a speaker, that outputs audio information e.g. voice. The output device is not limited to the above examples and may include various other devices. The detection apparatus 20 may be configured to be connectable to an external output device. The detection apparatus 20 may be configured to be able to output information or data to the external output device.

The detection apparatus 20 may be configured with a single server apparatus or a plurality of server apparatuses capable of communicating with each other. The detection apparatus 20 may be realized as a cloud server.

### Example of Operations of Detection System 1

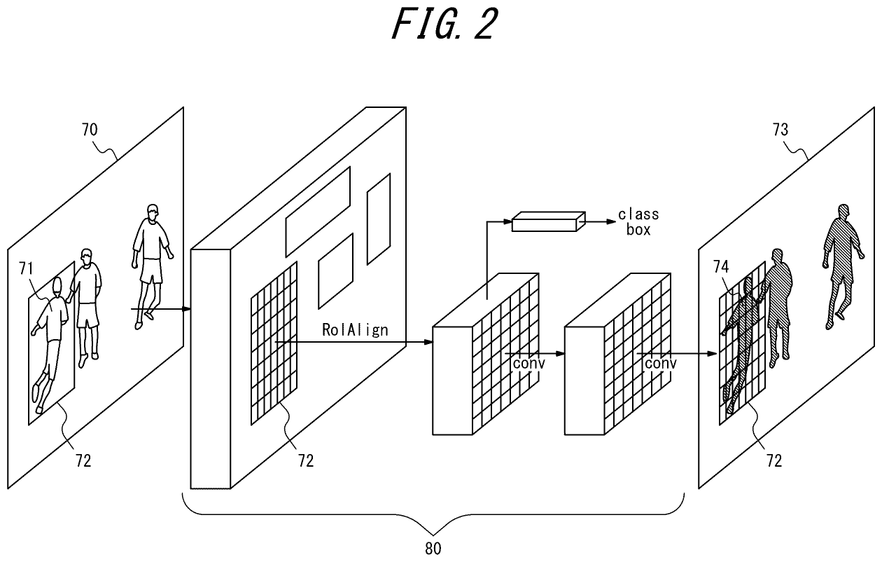

The detection system 1 according to the present embodiment captures images of a detection target region with the camera 10, and detects persons present in the detection target region by analyzing the captured images with the detection apparatus 20. The detection apparatus 20 may use a detection model 80 illustrated in FIG. 2 for detecting the persons. The detection model 80 illustrated in FIG. 2 is a model of Mask Region based Convolutional Neural Networks (R-CNN).

The detection apparatus 20 inputs, into the detection model 80, an image captured by the camera 10 capturing the detection target region, as an input image 70. The input image 70 includes pixels in which a detection target person 71 is captured. The detection model 80 detects the detection target person 71 captured in the input image 70, and identifies a person detection rectangle 72. The detection model 80 may include a layer that identifies the person detection rectangle 72 in which the detection target person 71 is captured. The detection model 80 may identify the person detection rectangle 72 by executing RoI Align. The detector 22 of the detection apparatus 20 may correspond to the layer that identifies the person detection rectangle 72.

The detection apparatus 20 acquires time-series data of images, and inputs the images captured at multiple times into the detection model 80 to identify a person detection rectangle 72 in an image captured at each time.

The tracker 24 of the detection apparatus 20 associates person detection rectangles 72 that have detected the same person, among person detection rectangles 72 identified in the images captured at different multiple times. The tracker 24 tracks the person detection rectangles 72 of the same person over time.

The segmenter 26 of the detection apparatus 20 segments an image of the detection target person 71 captured in the person detection rectangle 72, and outputs the result as a person region 74 of the detection target person 71. The detection model 80 may include a layer that executes segmentation. The detection model 80 may include a classifier.

Through the above operations, the detection apparatus 20 can detect a person from captured images and execute segmentation, to acquire the results of identifying regions in which the person is captured. The detection model 80 may generate an output image 73 that displays the person region 74 superimposed on the input image 70. The detection apparatus 20 may acquire an image in which the result of identifying the region in which the person is captured in the captured image is superimposed on the captured image.

Here, the segmenter 26 may not be able to stably execute segmentation due to changes in the way the detection target person 71 appears over time in the time-series data of captured images. For example, when light applied to the detection target person 71 changes in images captured at multiple times, the output of segmentation of the detection target person 71 in an image captured at a certain time may decrease, thus no segmentation result may be obtained. Also, when the way the detection target person 71 is captured is changed due to the motion of the detection target person 71 in images captured at multiple times, the output of segmentation of the detection target person 71 in an image captured at a certain time may decrease, thus no segmentation result may be obtained.

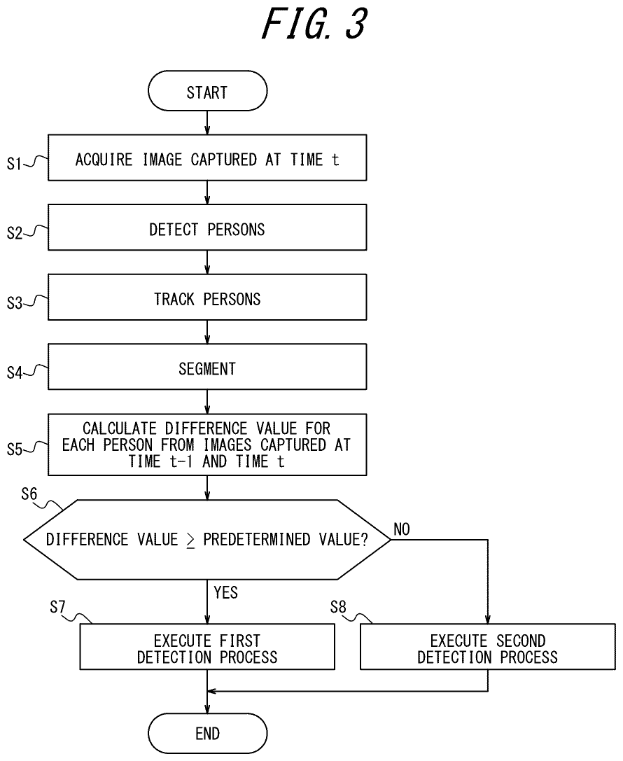

Therefore, the detection apparatus 20 according to the present disclosure varies how to adopt the execution results of segmentation of the detection target person 71 according to the motion or changes in appearance of the detection target person 71. The detection apparatus 20 may execute a person detection method that includes the procedure of the flowchart illustrated in FIG. 3, to realize the processes described above. The person detection method may be realized as a person detection program to be executed by a processor of the detection apparatus 20. The person detection program may be stored in a non-transitory computer readable medium.

The detection apparatus 20 acquires an image captured at time t from the camera 10 (S1).

The detector 22 of the detection apparatus 20 detects persons captured in the image (S2). The detector 22 generates person detection rectangles that enclose the detected persons.

The tracker 24 of the detection apparatus 20 tracks the persons captured in the image (S3). The tracker 24 identifies, in time-series data of captured images including images captured at times before time t, whether persons captured in images captured at multiple times are the same persons, and tracks the motion of persons who are identified to be the same persons.

The segmenter 26 of the detection apparatus 20 segments the detected persons (S4).

The detection apparatus 20 calculates, from images captured at time t-1 and time t, a difference value for each of persons captured in both images captured at time t-1 and time t (S5). In other words, the detection apparatus 20 acquires a difference value of time-series data of multiple captured images.

For example, the detection apparatus 20 may calculate a parameter regarding a person detection rectangle for each of the images captured at time t-1 and time t, and calculate, as a difference value, the absolute value of a difference in the parameter regarding the person detection rectangle between the images captured at time t-1 and time t. The parameter regarding the person detection rectangle may include the width or height of the person detection rectangle, the X coordinate of the left or right edge of the person detection rectangle, the Y coordinate of the upper or lower edge of the person detection rectangle, the XY coordinates of each of the four corners of the person detection rectangle, the center coordinates of the person detection rectangle, or the like. In other words, the detection apparatus 20 may calculate a difference value based on the coordinates of the captured images.

The detection apparatus 20 may calculate a difference value based on a pattern of a region enclosed by the person detection rectangle, between the images captured at time t-1 and time t. The detection apparatus 20 may calculate the average value of pixel brightness or the like in the region enclosed by the person detection rectangle in each of the images captured at time t-1 and time t, and calculate the absolute value of the difference of the calculated average values, as a difference value based on the pattern. The detection apparatus 20 may calculate the standard deviation of pixel brightness or the like in the region enclosed by the person detection rectangle in each of the images captured at time t-1 and time t, and calculate the absolute value of the difference of the calculated standard deviations, as a difference value based on the pattern. The detection apparatus 20 may calculate an optical flow in the region enclosed by the person detection rectangle in each of the images captured at time t-1 and time t, and calculate the absolute value of the difference of the calculated optical flows, as a difference value based on the pattern.

The detection apparatus 20 determines whether the difference value is equal to or greater than a predetermined value (S6). The fact that the difference value is equal to or greater than the predetermined value means that the way the person is captured in the captured images has changed when the time progresses from t-1 to t. The change in the way the person is captured includes the movement of the person's position or a change in the person's posture. The change in the way the person is captured includes the way light is applied to the person. The predetermined value may be set as appropriate.

Upon determining that the difference value is equal to or greater than the predetermined value (S6: YES), the detection apparatus 20 executes a first detection process on segmentation results for the person whose difference value has been determined (S7). The first detection process is a process that adopts, as a segmentation result, only a segmentation result of the image captured at the latest time, that is, at time t. In the first detection process, a segmentation result of the image captured at a previous time, that is, at time t-1 or earlier is not adopted. The first detection process corresponds to a process of detecting a person based on a subsequent image in a time series, among multiple captured images used to acquire a difference value.

Upon determining that the difference value is less than the predetermined value, in other words, upon determining that the difference value is not equal to or greater than the predetermined value (S6: NO), the detection apparatus 20 executes a second detection process on the segmentation results for the person whose difference value has been determined (S8). The first detection process is a process that adopts, as a segmentation result, the result of averaging segmentation results of the images captured so far, that is, the images captured at time t and earlier. The second detection process may be a process that averages a segmentation result of the image captured at time t-1 and a segmentation result of the image captured at time t. In other words, the second detection process corresponds to a process of detecting a person based on previous and subsequent images in a time series, among multiple captured images used to acquire a difference value.

The captured images subjected to the accumulation of segmentation results do not include images captured at times earlier than when the difference value has been determined in the past to be equal to or greater than the predetermined value. For example, when the difference value is determined to be equal to or greater than the predetermined value at time t-x, captured images subjected to the accumulation of segmentation results are images captured at time t−x+1 and later. In other words, when the difference value between an image captured at a certain time and an image captured at one previous time is determined to be equal to or greater than the predetermined value, the accumulation of segmentation results of images captured prior to the time when the difference value has been determined to be equal to or greater than the predetermined value is reset. In this case, the second detection process corresponds to, when a state in which the difference value is less than the predetermined value has continued, a process of averaging segmentation results during the continuation period.

The second detection process is not limited to the process of averaging the segmentation results of the images captured at the multiple past times as described above. The second detection process may be, for example, a process of accumulating the segmentation results of the images captured at the past times. The second detection process may be a process of weighting each of the segmentation results of the images captured at the past times and averaging or accumulating the weighted segmentation results.

The detection apparatus 20 ends the execution of the procedure in the flowchart of FIG. 3 after executing the process of S7 or S8.

As described above, the detection apparatus 20 according to the present disclosure adopts the average of the past segmentation results when a change in the parameter regarding the person detection rectangle is small between the images captured at two times. This makes it possible for the detection apparatus 20 to acquire the segmentation result by using each of the multiple captured images with a small change in the parameter, even when the detection apparatus 20 loses a segmentation result despite a small change in the parameter. As a result, the stability of segmentation is enhanced.

In the example of operations described above, the detection apparatus 20 acquires the difference value in the parameter regarding the person detection rectangle in the time-series data of multiple captured images, but may determine which of the first detection process or the second detection process to execute based on a difference value in the time-series data of multiple captured images.

The detection apparatus 20 may execute the second detection process after detecting a person by executing the first detection process.

### Example of Configuration of Vehicle Control System 2

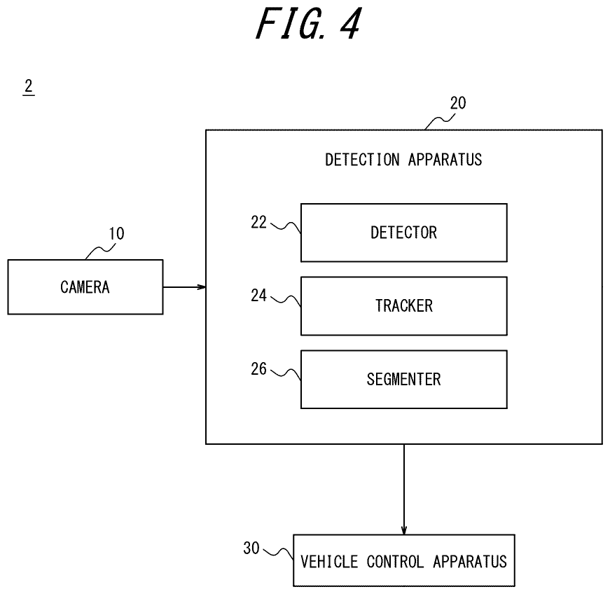

As illustrated in FIG. 4, the vehicle control system 2 includes a camera 10, a detection apparatus 20, and a vehicle control apparatus 30.

The vehicle control apparatus 30 controls a vehicle based on a person detection result from the camera 10 and the detection apparatus 20. The vehicle control apparatus 30 may include a processor, a memory, and an interface, as with the detection apparatus 20 of the detection system 1 described above. The vehicle is equipped with a door. The vehicle control apparatus 30 controls the opening and closing of the door.

The camera 10 and the detection apparatus 20 may be configured in the same manner as the camera 10 and the detection apparatus 20 of the detection system 1. The camera 10 may be installed inside the vehicle's cabin and capture images of the interior of the cabin as a detection target region. The camera 10 installed inside the cabin may capture images of the vehicle's passengers. The camera 10 may be installed outside the vehicle and capture images of the surroundings of the vehicle as a detection target region. The detection apparatus 20 may be mounted in the vehicle to be controlled by the vehicle control apparatus 30. The detection apparatus 20 may not be mounted in the vehicle. At least some components of the detection apparatus 20 may be mounted in the vehicle. At least some components of the detection apparatus 20 may not be mounted in the vehicle.

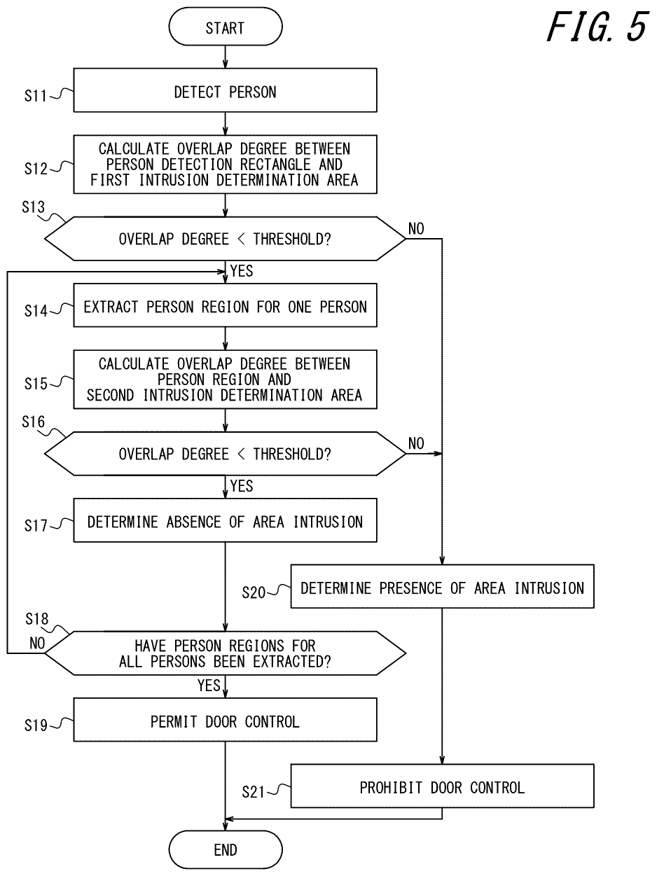

The vehicle control system 2 may execute a vehicle control method that includes the procedure of the flowchart illustrated in FIG. 5, to detect the passengers of the vehicle by the detection apparatus 20 and control, by the vehicle control apparatus 30, the opening and closing of the vehicle's door based on the detection results of the passengers. The vehicle control method may be implemented as a vehicle control program to be executed by a processor of the vehicle control apparatus 30. The vehicle control program may be stored on a non-transitory computer readable medium.

The detection apparatus 20 detects a person from a captured image (S11). The detection apparatus 20 may detect a person from a captured image by executing the procedure of the flowchart in FIG. 3, and calculate a person detection rectangle and a person region of the detected person. The detection apparatus 20 outputs the calculation results of the person detection rectangle and the person region to the vehicle control apparatus 30.

The vehicle control apparatus 30 calculates the overlap degree between the person detection rectangle and a first intrusion determination area in the captured image (S12). The first intrusion determination area is an area that is appropriately set as an area around the vehicle's door. The overlap degree may be the area in which the person detection rectangle and the first intrusion determination area overlap in the captured image. The overlap degree may be the ratio of the area in which the person detection rectangle and the first intrusion determination area overlap to the area of the person detection rectangle. The overlap degree between the person detection rectangle and the first intrusion determination area is also referred to as a first overlap degree.

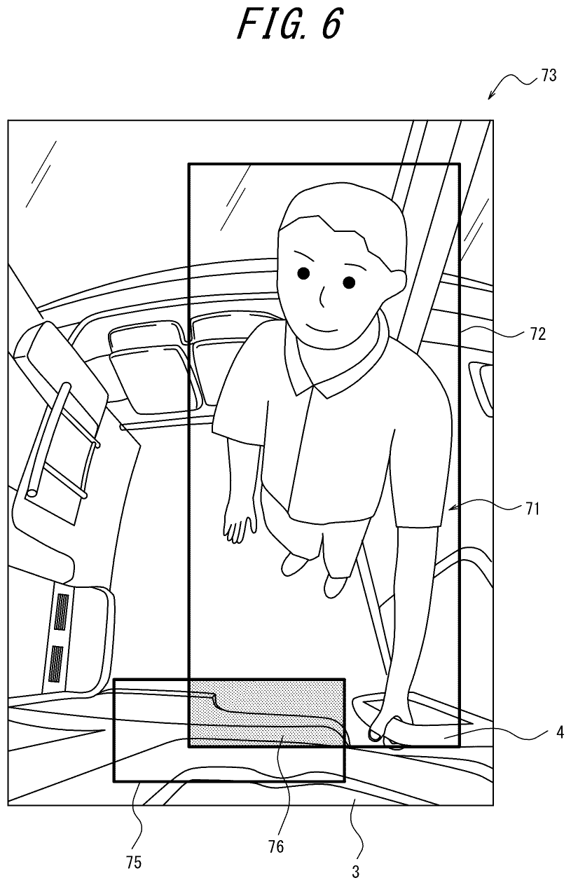

Specifically, as illustrated in FIG. 6, the vehicle control apparatus 30 may acquire the calculation result of a person detection rectangle 72 corresponding to a detection target person 71, who is a passenger of the vehicle, as the result of detecting the detection target person 71 from an image capturing a state in which the detection target person 71 is standing near the vehicle's door 3. The vehicle control apparatus 30 may calculate an overlap region 76 between a first intrusion determination area 75 and the person detection rectangle 72. The vehicle control apparatus 30 may calculate the ratio of the area of the overlap region 76 to the area of the person detection rectangle 72, as an overlap degree.

The vehicle control apparatus 30 determines whether the overlap degree calculated in S12 is less than a threshold (S13). The threshold in S13 is a value that is set appropriately and is also referred to as a first overlap threshold. As illustrated in FIG. 6, the vehicle control apparatus 30 may acquire the result of detecting the detection target person 71, who is a passenger of the vehicle, from the image capturing the state in which the detection target person 71 is standing near the vehicle's door 3. The detection target person 71 is extending only his arm to grab a handrail 4 located next to the door 3. Therefore, the person detection rectangle 72 is calculated to be wider than an actual range in which the detection target person 71 is captured. When the ratio of the area of the overlap region 76 to the area of the person detection rectangle 72 is calculated as the overlap degree, the vehicle control apparatus 30 may set the first overlap threshold at 1/9, for example. The value of the first overlap threshold is not limited to the illustrated value and may be set to other values as appropriate.

When the overlap degree is equal to or more than the threshold, that is, when the overlap degree is not less than the threshold (S13: NO), the vehicle control apparatus 30 proceeds to the process of S20. When the overlap degree is less than the threshold (S13: YES), the vehicle control apparatus 30 extracts a person region of one person among one or more persons captured in the captured image (S14). The vehicle control apparatus 30 calculates the overlap degree between the person region of the one person extracted in S14 and a second intrusion determination area (S15). The second intrusion determination area is an area set appropriately around the vehicle's door. The second intrusion determination area may be set in the same area as the first intrusion determination area. The second intrusion determination area may be set in an area that overlaps with at least part of the first intrusion determination area. The second intrusion determination area may be set to a larger area than the first intrusion determination area. The second intrusion determination area may be set to a smaller area than the first intrusion determination area. The overlap degree may be the area in which the person region and the second intrusion determination area overlap in the captured image. The overlap degree may be the ratio of the area in which the person region and the second intrusion determination area overlap to the area of the person region. The overlap degree between the person region and the second intrusion determination area is also referred to as a second overlap degree.

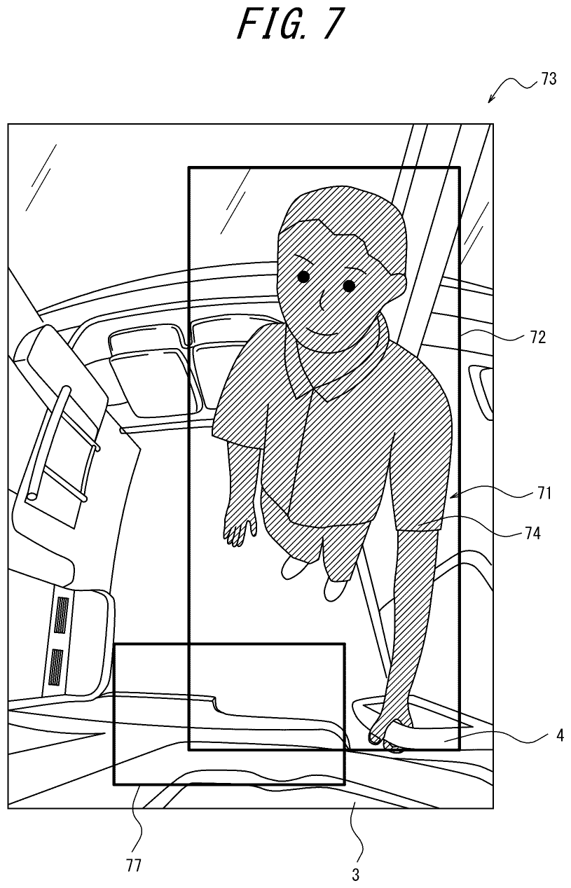

Specifically, as illustrated in FIG. 7, the vehicle control apparatus 30 may acquire the calculation result of a person region 74 corresponding to the detection target person 71, who is a passenger of the vehicle, as the result of detecting the detection target person 71 from the image capturing a state in which the detection target person 71 is standing near the vehicle's door 3. The vehicle control apparatus 30 may calculate a region in which the second intrusion determination area 77 and the person region 74 overlap. The vehicle control apparatus 30 may calculate the ratio of the area in which the second intrusion determination area 77 and the person region 74 overlap to the area of the person region 74, as the overlap degree.

The vehicle control apparatus 30 determines whether the overlap degree calculated in S15 is less than a threshold (S16). The threshold in S16 is a value set appropriately and is also referred to as a second overlap threshold. When the overlap degree is equal to or more than the threshold, that is, when the overlap degree is not less than the threshold (S16: NO), the vehicle control apparatus 30 proceeds to the process of S20. When the overlap degree is less than the threshold (S16: YES), the vehicle control apparatus 30 determines that there is no area intrusion by the one person corresponding to the extracted person region (S17). The vehicle control apparatus 30 determines whether person regions 74 for all the persons captured in the image have been extracted (S18). When the person regions 74 for all the persons have not been extracted (S18: NO), the vehicle control apparatus 30 returns to the process of S14 to extract a person region 74 of an unextracted person. When the person regions 74 for all the persons have been extracted (S18: YES), the vehicle control apparatus 30 determines that there is no area intrusion by anyone captured in the image and permits the opening and closing control of the door (S19). After executing the process of S19, the vehicle control apparatus 30 ends the execution of the procedure in the flowchart of FIG. 5.

When the overlap degree is determined to be equal to or more than the threshold in the process of S13 or S16, that is, when the overlap degree is not less than the threshold (S13 or S16: NO), the vehicle control apparatus 30 determines that there is an area intrusion by at least one person captured in the image (S20). When at least one person is entering the area around door 3, opening and closing the vehicle's door 3 may pose a risk that the person who is entering the area might collide with or be entrapped with the opening or closing door 3. Therefore, when it is determined that there is an area intrusion by at least one person, the vehicle control apparatus 30 prohibits the opening and closing control of the door (S21). The vehicle control apparatus 30 may display a message on a screen or output the message as sound, such as “Please stay away from the door for safety,” to move people away from the area around door 3 for door opening and closing control. After executing the process of S21, the vehicle control apparatus 30 ends the execution of the procedure in the flowchart of FIG. 5.

As described above, the vehicle control system 2 according to the present disclosure can control the opening and closing of the door by determining whether a person has entered a predetermined space such as an area around the door, based on the result of detecting a person from a captured image by the detection apparatus 20. At that time, the stability of segmentation by the detection apparatus 20 is enhanced, thus resulting in improvement in the accuracy of determining area intrusion by a person based on a person region.

The vehicle control system 2 may prohibit the departure of the vehicle when a person detected by the detection apparatus 20 is present in a predetermined space around the vehicle, and may permit the departure of the vehicle when the detected person is not present in the predetermined space around the vehicle. In other words, the vehicle control system 2 may prohibit the execution of a predetermined operation of the vehicle, such as opening and closing the vehicle's door or the departure of the vehicle, when a person detected by the detection apparatus 20 is present in a predetermined space provided in the vehicle.

While an embodiment of the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

In the embodiment described above, the detection apparatus 20 detects a person based on previous and subsequent images in a time series, among multiple captured images used to acquire a difference value. When there is no change in the captured images over time, the detection apparatus 20 may detect a person based only on the previous image, without relying on the subsequent image. In other words, the detection apparatus 20 may detect a person based on the previous image in the time series, among the multiple captured images used to acquire the difference value, and may detect a person based on both the previous and subsequent images.

Examples of some embodiments of the present disclosure are described below. However, it should be noted that the embodiments of the present disclosure are not limited to these.

### Appendix 1

A person detection method comprising:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

### Appendix 2

The person detection method according to appendix 1, wherein the second detection process includes, when the difference value is less than the predetermined value, detecting a person based on the previous and subsequent images in the time series, among the multiple captured images used to acquire the difference value, by averaging a person detection result based on the previous image in the time series and a person detection result based on the subsequent image in the time series.

### Appendix 3

The person detection method according to appendix 2, comprising when a state in which the difference value is less than the predetermined value has continued, detecting a person by averaging person detection results during a continuation period.

### Appendix 4

The person detection method according to any one of appendices 1 to 3, wherein the difference value is a value based on coordinates of the captured images.

### Appendix 5

The person detection method according to any one of appendices 1 to 3, wherein the difference value is a value based on patterns of the captured images.

### Appendix 6

The person detection method according to any one of appendices 1 to 5, wherein the second detection process is executed after a person has been detected by execution of the first detection process.

### Appendix 7

A vehicle control method comprising prohibiting execution of a predetermined operation of a vehicle when a person detected by the person detection method according to any one of appendices 1 to 6 is present in a predetermined space provided in the vehicle.

### Appendix 8

A non-transitory computer readable medium storing a person detection program configured to cause a processor to execute operations, the operations comprising:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

### Appendix 9

The non-transitory computer readable medium according to appendix 8, wherein the operations include, as the second detection process, when the difference value is less than the predetermined value, detecting a person based on the previous and subsequent images in the time series, among the multiple captured images used to acquire the difference value, by averaging a person detection result based on the previous image in the time series and a person detection result based on the subsequent image in the time series.

### Appendix 10

The non-transitory computer readable medium according to appendix 9, wherein the operations include when a state in which the difference value is less than the predetermined value has continued, detecting a person by averaging person detection results during a continuation period.

### Appendix 11

The non-transitory computer readable medium according to any one of appendices 8 to 10, wherein the difference value is a value based on coordinates of the captured images.

### Appendix 12

The non-transitory computer readable medium according to any one of appendices 8 to 10, wherein the difference value is a value based on patterns of the captured images.

### Appendix 13

The non-transitory computer readable medium according to any one of appendices 8 to 12, wherein the second detection process is executed after a person has been detected by execution of the first detection process.

### Appendix 14

A person detection apparatus comprising a controller configured to:
acquire a difference value of time-series data of multiple captured images;
when the difference value is equal to or greater than a predetermined value, execute a first detection process to detect a person based on a subsequent image in a time series, among the multiple captured images used to acquire the difference value; and
when the difference value is less than the predetermined value, execute a second detection process to detect a person based on a previous image in the time series, among the multiple captured images used to acquire the difference value.

### Appendix 15

The person detection apparatus according to appendix 14, wherein the controller is configured to, as the second detection process, when the difference value is less than the predetermined value, detect a person based on the previous and subsequent images in the time series, among the multiple captured images used to acquire the difference value, by averaging a person detection result based on the previous image in the time series and a person detection result based on the subsequent image in the time series.

### Appendix 16

The person detection apparatus according to appendix 15, wherein the controller is configured to, when a state in which the difference value is less than the predetermined value has continued, detect a person by averaging person detection results during a continuation period.

### Appendix 17

The person detection apparatus according to any one of appendices 14 to 16, wherein the difference value is a value based on coordinates of the captured images.

### Appendix 18

The person detection apparatus according to any one of appendices 14 to 16, wherein the difference value is a value based on patterns of the captured images.

### Appendix 19

The person detection apparatus according to any one of appendices 14 to 18, wherein the second detection process is executed after a person has been detected by execution of the first detection process.

### Appendix 20

A vehicle control system comprising:
the person detection apparatus according to any one of appendices 14 to 19; and
a vehicle control apparatus configured to prohibit execution of a predetermined operation of a vehicle when a person detected by the person detection apparatus is present in a predetermined space provided in the vehicle.

1. A person detection method comprising:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

2. The person detection method according to claim 1, wherein the second detection process includes, when the difference value is less than the predetermined value, detecting a person based on the previous and subsequent images in the time series, among the multiple captured images used to acquire the difference value, by averaging a person detection result based on the previous image in the time series and a person detection result based on the subsequent image in the time series.

3. The person detection method according to claim 2, comprising when a state in which the difference value is less than the predetermined value has continued, detecting a person by averaging person detection results during a continuation period.

4. The person detection method according to claim 1, wherein the difference value is a value based on coordinates of the captured images.

5. The person detection method according to claim 1, wherein the difference value is a value based on patterns of the captured images.

6. The person detection method according to claim 1, wherein the second detection process is executed after a person has been detected by execution of the first detection process.

7. A vehicle control method comprising prohibiting execution of a predetermined operation of a vehicle when a person detected by the person detection method according to claim 1 is present in a predetermined space provided in the vehicle.

8. A non-transitory computer readable medium storing a person detection program configured to cause a processor to execute operations, the operations comprising:
acquiring a difference value of time-series data of multiple captured images;
when the difference value is equal to or greater than a predetermined value, executing a first detection process to detect a person based on a subsequent image in a time series, among the multiple captured images used to acquire the difference value; and
when the difference value is less than the predetermined value, executing a second detection process to detect a person based on a previous image in the time series, among the multiple captured images used to acquire the difference value.

9. The non-transitory computer readable medium according to claim 8, wherein the operations include, as the second detection process, when the difference value is less than the predetermined value, detecting a person based on the previous and subsequent images in the time series, among the multiple captured images used to acquire the difference value, by averaging a person detection result based on the previous image in the time series and a person detection result based on the subsequent image in the time series.

10. The non-transitory computer readable medium according to claim 9, wherein the operations include when a state in which the difference value is less than the predetermined value has continued, detecting a person by averaging person detection results during a continuation period.

11. The non-transitory computer readable medium according to claim 8, wherein the difference value is a value based on coordinates of the captured images.

12. The non-transitory computer readable medium according to claim 8, wherein the difference value is a value based on patterns of the captured images.

13. The non-transitory computer readable medium according to claim 8, wherein the second detection process is executed after a person has been detected by execution of the first detection process.

14. A person detection apparatus comprising a controller configured to:
acquire a difference value of time-series data of multiple captured images;
when the difference value is equal to or greater than a predetermined value, execute a first detection process to detect a person based on a subsequent image in a time series, among the multiple captured images used to acquire the difference value; and
when the difference value is less than the predetermined value, execute a second detection process to detect a person based on a previous image in the time series, among the multiple captured images used to acquire the difference value.

15. The person detection apparatus according to claim 14, wherein the controller is configured to, as the second detection process, when the difference value is less than the predetermined value, detect a person based on the previous and subsequent images in the time series, among the multiple captured images used to acquire the difference value, by averaging a person detection result based on the previous image in the time series and a person detection result based on the subsequent image in the time series.

16. The person detection apparatus according to claim 15, wherein the controller is configured to, when a state in which the difference value is less than the predetermined value has continued, detect a person by averaging person detection results during a continuation period.

17. The person detection apparatus according to claim 14, wherein the difference value is a value based on coordinates of the captured images.

18. The person detection apparatus according to claim 14, wherein the difference value is a value based on patterns of the captured images.

19. The person detection apparatus according to claim 14, wherein the second detection process is executed after a person has been detected by execution of the first detection process.

20. A vehicle control system comprising:
the person detection apparatus according to claim 14; and
a vehicle control apparatus configured to prohibit execution of a predetermined operation of a vehicle when a person detected by the person detection apparatus is present in a predetermined space provided in the vehicle.
